(19) United States
(12) Patent Application Publication
(10) Pub. No.: US 2023/0092026 A1
(43) Pub. Date: Mar. 23, 2023

(54) PROCESSING DEVICE, PROCESSING METHOD, AND NON-TRANSITORY STORAGE MEDIUM

(71) Applicant: NEC Corporation, Minato-ku, Tokyo (JP)

(72) Inventors: Noritaka YAMASHITA, Tokyo (JP); Kenji SOBATA, Tokyo (JP); Masayuki SAKATA, Tokyo (JP); Yuki CHIBA, Tokyo (JP)

(73) Assignee: NEC Corporation, Minato-ku, Tokyo (JP)

(21) Appl. No.: 17/801,463

(22) PCT Filed: Mar. 19, 2020
(86) PCT No.: PCT/JP2020/012306

§ 371 Date: Aug. 22, 2022

(51) Int. Cl. G07C 5/02

(52) U.S. Cl. CPC G07C 5/02

(57) ABSTRACT

The present invention provides a processing apparatus (10) including: a determination unit (12) determining a predetermined vehicle state and a predetermined ambient environment, based on user vehicle data indicating a vehicle state and an ambient environment when a user uses a vehicle; a computation unit (13) computing a degree of similarity between the predetermined vehicle state and the predetermined ambient environment, and a vehicle state and an ambient environment indicated by a vehicle running test scenario; and an output unit (14) outputting a computation result by the computation unit (13).

### TECHNICAL FIELD

The present invention relates to a processing apparatus, a processing method, and a program.

### Background Art

Patent Documents 1 to 4 disclose technologies for collecting running data of a vehicle, environmental data, and the like.

### RELATED DOCUMENT

### Patent Document

Patent Document 1: Japanese Patent Application Publication No. 2019-153291

Patent Document 2: Japanese Patent Application Publication No. 2019-123351

Patent Document 3: Japanese Patent Application Publication No. 2018-025539

Patent Document 4: Japanese Patent Application Publication No. 2016-001172

### DISCLOSURE OF THE INVENTION

### Technical Problem

A vehicle manufacturer performs vehicle running testing in a plurality of scenarios. A scenario is defined by a vehicle state, an ambient environment, and the like. While it is desirable to perform vehicle running testing in a scenario simulating every situation, it is difficult to completely cover every situation due to constraints on time, manpower, and the like. Therefore, it is desirable to perform vehicle running testing in a scenario simulating a high-priority situation. However, it is not easy to manually find a situation having high priority and not existing in existing scenarios. None of Patent Documents 1 to 4 describe or suggest the problem.

An example object of the present invention is to provide a technology for supporting scenario preparation of vehicle running testing.

### Solution to Problem

A processing apparatus according to an example aspect of the present invention includes:
a determination means for determining a predetermined vehicle state and a predetermined ambient environment, based on user vehicle data indicating a vehicle state and an ambient environment when a user uses a vehicle;
a computation means for computing a degree of similarity between the predetermined vehicle state and the predetermined ambient environment, and a vehicle state and an ambient environment indicated by a vehicle running test scenario; and
an output means for outputting a computation result by the computation means.

Further, a processing method according to an example aspect of the present invention includes, by a computer:
determining a predetermined vehicle state and a predetermined ambient environment, based on user vehicle data indicating a vehicle state and an ambient environment when a user uses a vehicle;
computing a degree of similarity between the predetermined vehicle state and the predetermined ambient environment, and a vehicle state and an ambient environment indicated by a vehicle running test scenario; and
outputting a computation result.

Further, a program according to an example aspect of the present invention causes a computer to function as:
a determination means for determining a predetermined vehicle state and a predetermined ambient environment, based on user vehicle data indicating a vehicle state and an ambient environment when a user uses a vehicle;
a computation means for computing a degree of similarity between the predetermined vehicle state and the predetermined ambient environment, and a vehicle state and an ambient environment indicated by a vehicle running test scenario; and
an output means for outputting a computation result by the computation means.

### ADVANTAGEOUS EFFECTS OF INVENTION

The present invention provides a technology for supporting scenario preparation of vehicle running testing.

### BRIEF DESCRIPTION OF THE DRAWINGS

FIG. 1 is a diagram illustrating an example of a hardware configuration of a processing apparatus according to the present example embodiment.

FIG. 2 is an example of a functional block diagram of the processing apparatus according to the present example embodiment.

FIG. 3 is a diagram schematically illustrating an example of information processed by the processing apparatus according to the present example embodiment.

FIG. 4 is a diagram schematically illustrating an example of information output by the processing apparatus according to the present example embodiment.

FIG. 5 is a diagram schematically illustrating an example of information output by the processing apparatus according to the present example embodiment.

FIG. 6 is a diagram schematically illustrating an example of information output by the processing apparatus according to the present example embodiment.

FIG. 7 is a flowchart illustrating an example of a flow of processing in the processing apparatus according to the present example embodiment.

FIG. 8 is a flowchart illustrating an example of a flow of processing in the processing apparatus according to the present example embodiment.

FIG. 9 is a diagram schematically illustrating an example of information output by a processing apparatus according to the present example embodiment.

FIG. 10 is a diagram schematically illustrating an example of information output by the processing apparatus according to the present example embodiment.

FIG. 11 is a flowchart illustrating an example of a flow of processing in the processing apparatus according to the present example embodiment.

### DESCRIPTION OF EMBODIMENTS

### First Example Embodiment

### Outline

First, an outline of a processing apparatus according to the present example embodiment will be described. The processing apparatus provides support or the like for a developer by collecting and centrally managing vehicle-related data generated in various scenes and processing the data by a characteristic technique. Specifically, the processing apparatus supports scenario preparation of vehicle running testing by processing vehicle-related data related to vehicle running testing and vehicle-related data generated at the time of use by a user, by a characteristic technique.

Vehicle-related data related to vehicle running testing include information indicating a vehicle running test scenario (may be hereinafter simply referred to as a “scenario”). Vehicle-related data may further include a result of vehicle running testing in each scenario. A vehicle running test scenario is defined by a vehicle state and an ambient environment.

Vehicle-related data generated at the time of use by a user are data indicating a vehicle state and an ambient environment when the user uses the vehicle and are generated by, for example, a sensor or the like mounted on the vehicle.

Based on vehicle-related data generated at the time of use by a user, the processing apparatus determines a predetermined vehicle state and a predetermined ambient environment in which it is desirable to perform vehicle running testing (may be hereinafter simply referred to as “a predetermined vehicle state and a predetermined ambient environment”). For example, a predetermined vehicle state and a predetermined ambient environment may be a vehicle state and an ambient environment indicated by vehicle-related data when (before or after) a trouble occurs in the vehicle, may be a vehicle state and an ambient environment that appear frequently when a user uses the vehicle, or may be a vehicle state and an ambient environment of another type.

Then, the processing apparatus computes a degree of similarity between “the determined predetermined vehicle state and the determined predetermined ambient environment” and “a vehicle state and an ambient environment indicated by a vehicle running test scenario” and outputs the result.

Thus, based on vehicle-related data generated at the time of use by a user, the processing apparatus can determine a predetermined vehicle state and a predetermined ambient environment in which it is desirable to perform vehicle running testing (a high-priority situation). Then, the processing apparatus can check whether a scenario indicating the determined predetermined vehicle state and the determined predetermined ambient environment, or a similar scenario exists and output the result. The processing apparatus supports scenario preparation of vehicle running testing by such processing.

### Hardware Configuration

Next, an example of a hardware configuration of the processing apparatus will be described. Each functional unit in the processing apparatus is implemented by any combination of hardware and software centering on a central processing unit (CPU), a memory, a program loaded into the memory, a memory unit storing the program [capable of storing not only a program previously stored in a shipping stage of the apparatus but also a program downloaded from a storage medium such as a compact disc (CD) or from a server or the like on the Internet], such as a hard disk, and a network connection interface in any computer. Then, it should be understood by a person skilled in the art that various modifications to the implementation method and the apparatus can be made.

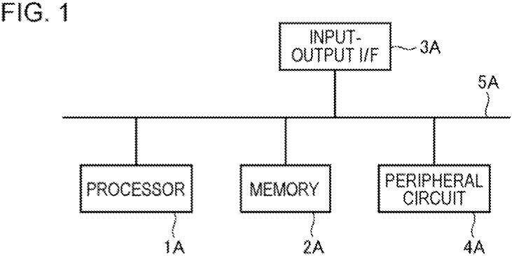

FIG. 1 is a block diagram illustrating a hardware configuration of the processing apparatus. As illustrated in FIG. 1, the processing apparatus includes a processor 1A, a memory 2A, an input-output interface 3A, a peripheral circuit 4A, and a bus 5A. The peripheral circuit 4A includes various modules. The processing apparatus may not include the peripheral circuit 4A. Note that the processing apparatus may be configured with a plurality of physically and/or logically separated apparatuses or may be configured with one physically and/or logically integrated apparatus. When the processing apparatus is configured with a plurality of physically and/or logically separated apparatuses, each of the plurality of apparatuses may include the aforementioned hardware configuration.

The bus 5A is a data transmission channel for the processor 1A, the memory 2A, the peripheral circuit 4A, and the input-output interface 3A to transmit and receive data to and from one another. Examples of the processor 1A include arithmetic processing units such as a CPU and a graphics processing unit (GPU). Examples of the memory 2A include memories such as a random access memory (RAM) and a read only memory (ROM). The input-output interface 3A includes an interface for acquiring information from an input apparatus, an external apparatus, an external server, an external sensor, a camera, and the like, and an interface for outputting information to an output apparatus, the external apparatus, the external server, and the like. Examples of the input apparatus include a keyboard, a mouse, a microphone, a physical button, and a touch panel. Examples of the output apparatus include a display, a speaker, a printer, and a mailer. The processor 1A can give an instruction to each module and perform an operation, based on the operation result by the module.

### Functional Configuration

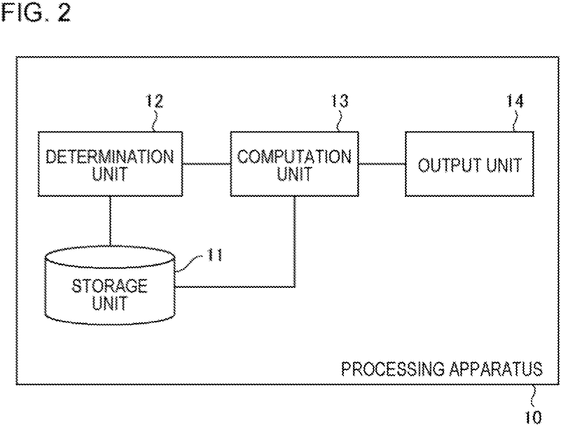

Next, a functional configuration of the processing apparatus will be described. As illustrated in FIG. 2, a processing apparatus 10 includes a storage unit 11, a determination unit 12, a computation unit 13, and an output unit 14.

The storage unit 11 stores vehicle-related data. The vehicle-related data include running test data and user vehicle data.

Running test data are data related to running testing of a vehicle and may include various types of data. The running test data include information indicating a content of each of a plurality of vehicle running test scenarios. Note that the running test data may further include data indicating a result of vehicle running testing in each scenario, and the like.

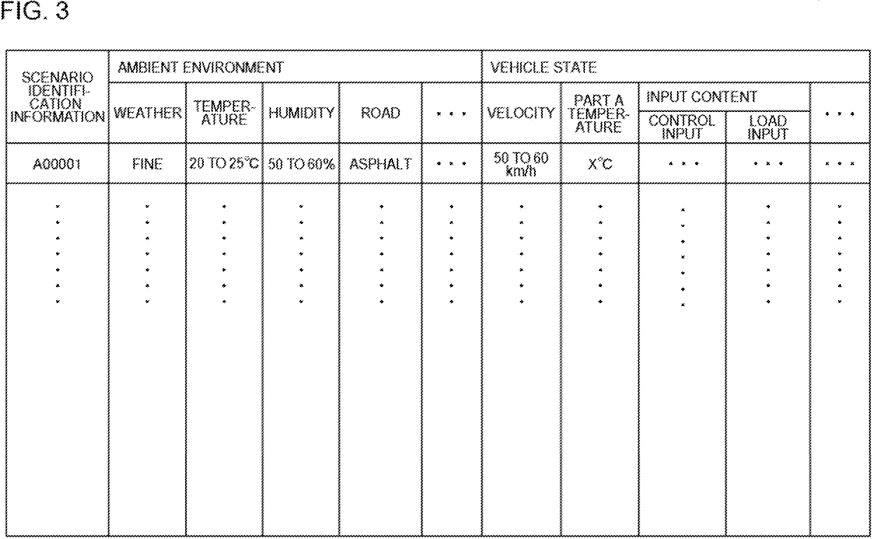

FIG. 3 schematically illustrates an example of information indicating a content of each of a plurality of vehicle running test scenarios. In the illustrated information, scenario identification information for distinguishing the plurality of scenarios from one another, information about an ambient environment, and information about a vehicle state are tied to one another. A content of a scenario is defined by an ambient environment and a vehicle state. Note that a content of a scenario may be defined by using yet another type of information.

An ambient environment indicates a factor that may affect an environment around a vehicle at the time of test execution and, more specifically, a test result; and examples of the ambient environment include weather, temperature, humidity, a type of road on which a vehicle runs, and existence or a state of a predetermined target object in the surroundings of the vehicle (such as another vehicle, a pedestrian, a signal, and a utility pole).

A vehicle state indicates a factor that may affect a state of the vehicle at the time of test execution and, more specifically, a test result; and examples of the vehicle state include velocity, part A temperature, and an input content (such as a control input and a load input), as illustrated.

For example, a scenario identified by scenario identification information “A00001” illustrated in FIG. 3 indicates performing vehicle running testing under a condition of the weather being “fine,” the temperature at “20 to 25° C.,” the humidity at “50 to 60%,”, the road on which the vehicle runs being “asphalt,” the velocity of the vehicle at “50 to 60 km/h,” part A temperature at “X°C” and the like.

User vehicle data are data indicating a vehicle state and an ambient environment when a user uses the vehicle. The user vehicle data may be generated by using every existing technology. For example, data indicating a vehicle state may be generated by a sensor mounted on the vehicle, or the like. Further, data indicating an ambient environment may be generated by a sensor mounted on the vehicle (such as a camera capturing an image of a road, a temperature sensor, a humidity sensor, a lidar acquiring surrounding information) or may be generated by another technique (such as acquisition from a server storing weather information).

User vehicle data preferably includes entire data in a plurality of parameters (such as weather, temperature, velocity, and part A temperature) indicated by a vehicle running test scenario. However, the type of sensor mounted on a vehicle when running testing is performed may differ from the type of sensor mounted on a sold vehicle. Further, the type of mounted sensor may vary by vehicle. Therefore, user vehicle data may include only partial data in a plurality of parameters indicated by a vehicle running test scenario.

User vehicle data may be data transmitted from a connected car continuously connected to the Internet to an external apparatus through the Internet. The connected car may transmit user vehicle data when (before or after) a trouble occurs in the vehicle to the external apparatus and may transmit user vehicle data to the external apparatus at predetermined time intervals when a trouble is not particularly occurring.

In addition, user vehicle data collected by each vehicle may be accumulated in a storage apparatus in the vehicle. User vehicle data when (before or after) a trouble occurs in a vehicle may be accumulated in the storage apparatus in the vehicle, and user vehicle data may be accumulated in the storage apparatus in the vehicle at predetermined time intervals when a trouble is not particularly occurring. Then, the user vehicle data may be input to the processing apparatus 10 at any timing and by any means and be stored into the storage unit 11.

Returning to FIG. 2, the determination unit 12 determines a predetermined vehicle state and a predetermined ambient environment in which it is desirable to perform vehicle running testing, based on user vehicle data stored in the storage unit 11. Determination processing examples performed by the determination unit 12 will be described below.

### Determination Processing Example 1

For example, a predetermined vehicle state and a predetermined ambient environment may be a vehicle state and an ambient environment indicated by vehicle-related data when (before or after) a trouble occurs in the vehicle. An example of processing of extracting, by the determination unit 12, data when (before or after) a trouble occurs in the vehicle from user vehicle data stored in the storage unit 11 will be described.

For example, a connected car may transmit, when a trouble occurs in the vehicle, information indicating occurrence of the trouble and user vehicle data at the time of (before or after) the occurrence of the trouble to the external apparatus. Then, the user vehicle data transmitted by the connected car through the processing may be tied to information indicating that the user vehicle data are data at the time of trouble occurrence and be stored in the storage unit 11. In this case, the determination unit 12 extracts, from user vehicle data stored in the storage unit 11, data tied to information indicating that the data are data at the time of trouble occurrence.

In addition, user vehicle data stored in the storage unit 11 may be tied to various types of index information such as date and time information when the data are generated, positional information of the vehicle when the data are generated, vehicle identification information, and vehicle type information. Then, the determination unit 12 may extract vehicle-related data when (before or after) a trouble occurs in the vehicle, by searching the user vehicle data stored in the storage unit 11, based on a search condition for determining data at the time of trouble occurrence specified by an operator. For example, the aforementioned search condition may be set as an expression acquired by joining the aforementioned pieces of index information by logical operators.

### Determination Processing Example 2

For example, a predetermined vehicle state and a predetermined ambient environment may be a vehicle state and an ambient environment an appearance frequency of which in user vehicle data is equal to or greater than a threshold value. The determination unit 12 can determine a vehicle state and an ambient environment an appearance frequency of which is equal to or greater than the threshold value by analyzing the user vehicle data stored in the storage unit 11. An appearance frequency is indicated by an appearance rate, an appearance time, or the like. For example, an appearance rate may be indicated by a ratio of a length t [min] in which each vehicle state and each ambient environment appears to a length T [min] of the user vehicle data or may be indicated by using another technique. An appearance time is indicated by a length of time in which the situation (the vehicle state and the ambient environment) appears.

The computation unit 13 computes a degree of similarity between the predetermined vehicle state and the predetermined ambient environment determined by the determination unit 12, and a vehicle state and an ambient environment indicated by a vehicle running test scenario. A degree of similarity is computed based on values of various parameters related to a vehicle state (such as velocity and part A temperature) and values of various parameters related to an ambient environment (such as weather and temperature). Details of an algorithm for computing a degree of similarity is a matter of design.

Further, by magnitude comparison between the computed degree of similarity and a preset reference value, the computation unit 13 may determine existence of a vehicle running test scenario with a degree of similarity to the predetermined vehicle state and the predetermined ambient environment determined by the determination unit 12 being equal to or greater than the reference value. Note that “a vehicle running test scenario with a degree of similarity to the predetermined vehicle state and the predetermined ambient environment being equal to or greater than the reference value” is a scenario in which a degree of similarity between a vehicle state and an ambient environment indicated by the scenario, and the predetermined vehicle state and the predetermined ambient environment is equal to or greater than the reference value (hereinafter the same).

The output unit 14 outputs a computation result by the computation unit 13. The output unit 14 can output the computation result through every output apparatus including a display, a projector, a mailer, a printer, and a speaker.

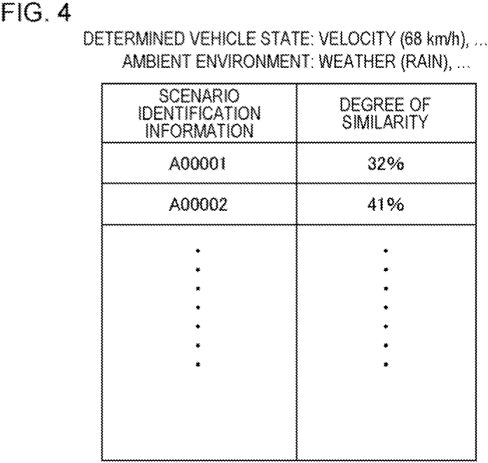

For example, the output unit 14 may display (for example, display in list form or successively display) a degree of similarity between the predetermined vehicle state and the predetermined ambient environment determined by the determination unit 12 and each of a plurality of vehicle running test scenarios, as illustrated in FIG. 4.

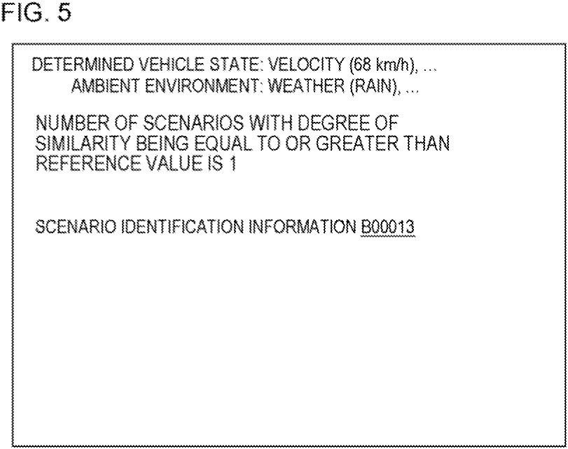

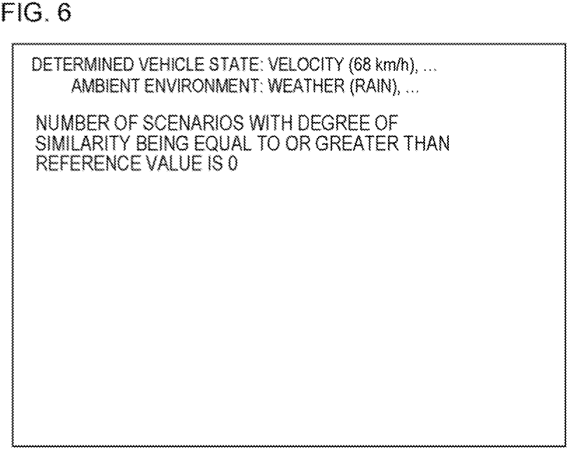

In addition, the output unit 14 may indicate existence of a vehicle running test scenario with a degree of similarity to the predetermined vehicle state and the predetermined ambient environment determined by the determination unit 12 being equal to or greater than the reference value, as illustrated in FIG. 5 and FIG. 6. Note that, when a vehicle running test scenario with a degree of similarity to the predetermined vehicle state and the predetermined ambient environment being equal to or greater than the reference value exists as illustrated in FIG. 5, information for identifying the scenario may be displayed. While the diagram illustrates an example of only one vehicle running test scenario with a degree of similarity to the predetermined vehicle state and the predetermined ambient environment being equal to or greater than the reference value being existent, a plurality of scenarios satisfying the condition may exist, and information for identifying each of the plurality of scenarios may be displayed (for example, displayed in list form or successively displayed). Then, when one of the displayed scenarios is selected, detailed information (such as details of the vehicle state and the ambient environment) of the scenario may be displayed.

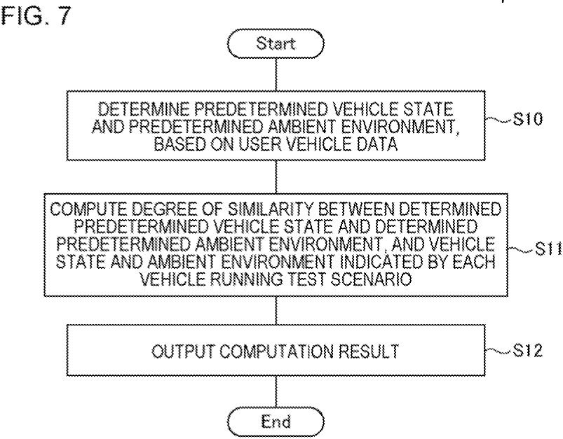

Next, an example of a flow of processing in the processing apparatus 10 will be described by using a flowchart in FIG. 7.

First, the determination unit 12 determines a predetermined vehicle state and a predetermined ambient environment, based on user vehicle data stored in the storage unit 11 (S10). For example, the determination unit 12 may determine a vehicle state and an ambient environment when a trouble occurs in the vehicle used by a user to be a predetermined vehicle state and a predetermined ambient environment. In addition, the determination unit 12 may determine a vehicle state and an ambient environment an appearance frequency of which in the user vehicle data is equal to or greater than a threshold value to be a predetermined vehicle state and a predetermined ambient environment.

Next, the computation unit 13 computes a degree of similarity between the predetermined vehicle state and the predetermined ambient environment determined in S10, and a vehicle state and an ambient environment indicated by a vehicle running test scenario (S11).

Then, the output unit 14 outputs the computation result in S11 (S12). For example, the output unit 14 displays a degree of similarity between the predetermined vehicle state and the predetermined ambient environment determined by the determination unit 12 and each of a plurality of vehicle running test scenarios, as illustrated in FIG. 4.

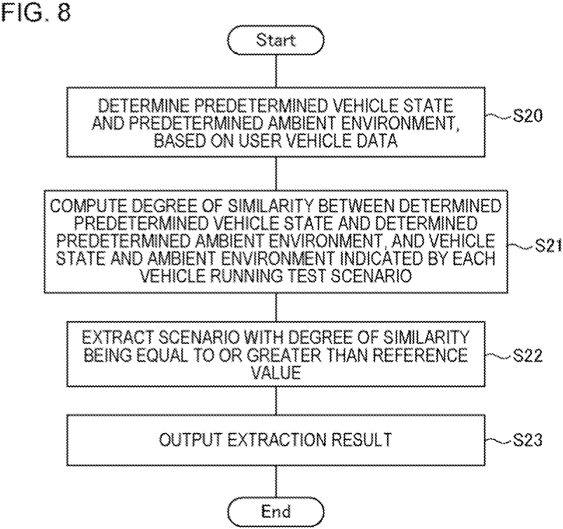

Next, another example of a flow of the processing in the processing apparatus 10 will be described by using a flowchart in FIG. 8.

First, the determination unit 12 determines a predetermined vehicle state and a predetermined ambient environment, based on user vehicle data stored in the storage unit 11 (S20). For example, the determination unit 12 may determine a vehicle state and an ambient environment when a trouble occurs in the vehicle used by a user to be a predetermined vehicle state and a predetermined ambient environment. In addition, the determination unit 12 may determine a vehicle state and an ambient environment an appearance frequency of which in the user vehicle data is equal to or greater than a threshold value to be a predetermined vehicle state and a predetermined ambient environment.

Next, the computation unit 13 computes a degree of similarity between the predetermined vehicle state and the predetermined ambient environment determined in S20, and a vehicle state and an ambient environment indicated by a vehicle running test scenario (S21). Next, by magnitude comparison between the computed degree of similarity and a preset reference value, the computation unit 13 extracts a vehicle running test scenario with a degree of similarity to the predetermined vehicle state and the predetermined ambient environment determined in S20 being equal to or greater than the reference value (S22).

Then, the output unit 14 outputs the extraction result in S22 (S23). When a vehicle running test scenario with a degree of similarity to the predetermined vehicle state and the predetermined ambient environment determined in S20 being equal to or greater than the reference value exists, the output unit 14 may output information as illustrated in FIG. 5. The number of extracted scenarios and information for identifying each of the extracted scenarios are displayed in the information. Then, when one of the displayed scenarios is selected, detailed information (such as the vehicle state and details of the ambient environment) of the scenario is displayed. On the other hand, when a vehicle running test scenario with a degree of similarity to the predetermined vehicle state and the predetermined ambient environment determined in S20 being equal to or greater than the reference value does not exist, the output unit 14 may output information as illustrated in FIG. 6. Nonexistence of an extracted scenario is indicated in the information.

### Advantageous Effect

The processing apparatus 10 can determine a predetermined vehicle state and a predetermined ambient environment in which it is desirable to perform vehicle running testing, based on user vehicle data generated when a user actually uses the vehicle. Thus, the processing apparatus 10 can determine a predetermined vehicle state and a predetermined ambient environment in which it is desirable to perform vehicle running testing, based on the user vehicle data, and therefore can determine a vehicle state and an ambient environment in which vehicle running testing truly should be performed (a high-priority situation), with a high degree of precision and efficiency.

Further, for example, the processing apparatus 10 can determine, as a predetermined vehicle state and a predetermined ambient environment, a vehicle state and an ambient environment when a trouble occurs in the vehicle used by a user or a vehicle state and an ambient environment appearing with a certain probability or higher when the user uses the vehicle. Such a processing apparatus 10 can determine a vehicle state and an ambient environment in which it is truly desirable to perform vehicle running testing, with a high degree of precision and efficiency.

Further, after determining a predetermined vehicle state and a predetermined ambient environment in which it is desirable to perform vehicle running testing, the processing apparatus 10 can compute and output a degree of similarity between the determined predetermined vehicle state and the determined predetermined ambient environment, and an already existing scenario. Further, the processing apparatus 10 can determine whether a scenario with a degree of similarity being equal to or greater than a reference value exists and output the result. Such a processing apparatus 10 enables an operator to easily recognize whether a scenario indicating a predetermined vehicle state and a predetermined ambient environment determined by the processing apparatus 10 already exists and, for example, to determine whether to add a new scenario.

Thus, the processing apparatus 10 can support scenario preparation of vehicle running testing.

### Second Example Embodiment

A processing apparatus 10 according to the present example embodiment has a function of, after determining a predetermined vehicle state and a predetermined ambient environment in which it is desirable to perform vehicle running testing, based on user vehicle data, analyzing a point in common and a point of difference between “the predetermined vehicle state and the predetermined ambient environment” and “an existing scenario” and outputting the result. Details of the aforementioned analysis processing will be described below in a case of a scenario with a degree of similarity to a predetermined vehicle state and a predetermined ambient environment being equal to or greater than a reference value being existent and a case of such a scenario being nonexistent, separately.

“A case where there is a vehicle running test scenario whose degree of similarity to a predetermined vehicle state and a predetermined ambient environment is equal to or greater than the reference value”

A computation unit 13 extracts a point of difference between “a vehicle state and an ambient environment”, indicated by a vehicle running test scenario whose degree of similarity to a predetermined vehicle state and a predetermined ambient environment is equal to or greater than the reference value being existent, and “the predetermined vehicle state and the predetermined ambient environment”. The extracted point of difference is a parameter out of parameters of vehicle states and the ambient environments, whose value indicated by the vehicle running test scenario and the reference value is different, or the difference is greater than a threshold value.

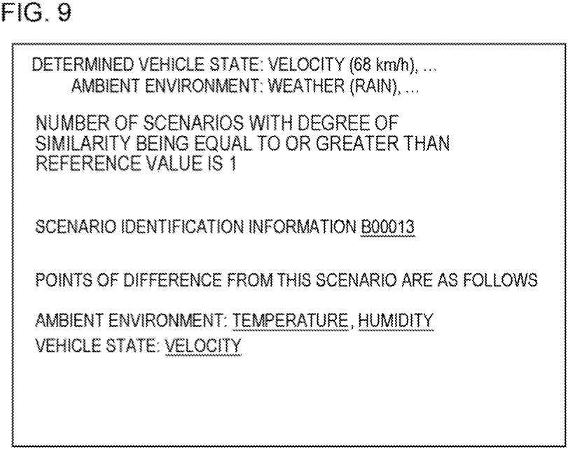

An output unit 14 outputs the aforementioned point of difference extracted by the computation unit 13 as a computation result by the computation unit 13. For example, as illustrated in FIG. 9, the output unit 14 may display information for identifying a scenario with a degree of similarity to a predetermined vehicle state and a predetermined ambient environment determined by a determination unit 12 being equal to or greater than a reference value and may also display the aforementioned point of difference in association with each scenario. In the illustrated example, the temperature and the humidity in the ambient environment and the velocity in the vehicle state are displayed as points of difference. Note that, when accepting input for selecting one point of difference (parameter) from the displayed points of difference (parameters), the output unit 14 may display the value of the selected parameter in the scenario.

“A case where there is no vehicle running test scenario whose degree of similarity to a predetermined vehicle state and a predetermined ambient environment is equal to or greater than the reference value”

The computation unit 13 extracts points in common across vehicle states and ambient environments indicated by a predetermined number of scenarios in descending order of degree of similarity. The extracted points in common is a parameter out of parameters of vehicle states and the ambient environments, whose value indicated by the vehicle running test scenario and the reference value is same, or a difference between them is smaller than a threshold value. The computation unit 13 may extract a parameter common to a predetermined ratio of scenarios out of a predetermined number of extracted scenarios as a point in common or may extract a parameter common to all of the predetermined number of extracted scenarios as a point in common.

Further, the computation unit 13 may extract a point different from the predetermined vehicle state and the predetermined ambient environment out of the extracted points in common.

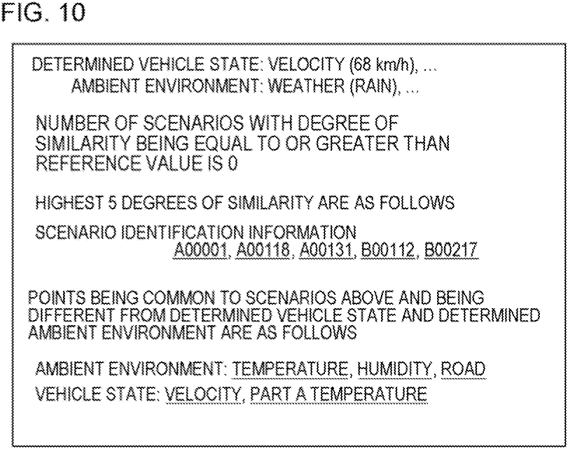

The output unit 14 outputs the aforementioned points in common as a computation result by the computation unit 13. Further, the output unit 14 can output a point different from the predetermined vehicle state and the predetermined ambient environment out of the aforementioned points in common as a computation result by the computation unit 13. For example, as illustrated in FIG. 10, the output unit 14 may display information for identifying a predetermined number of scenarios in descending order of degree of similarity to the predetermined vehicle state and the predetermined ambient environment determined by the determination unit 12 and may also display a point in common across the displayed scenarios, the point in common being different from the predetermined vehicle state and the predetermined ambient environment. Note that, when accepting input for selecting one parameter out of the displayed parameters, the output unit 14 may display a value of the selected parameter in the displayed scenario.

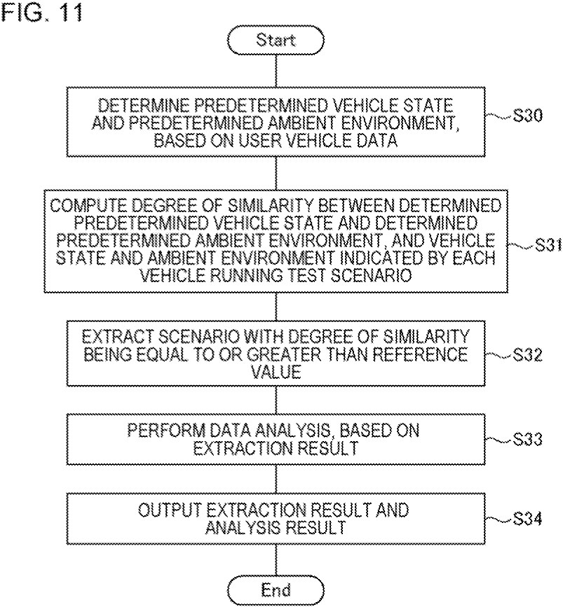

Next, an example of a flow of the processing in the processing apparatus 10 will be described by using a flowchart in FIG. 11.

First, the determination unit 12 determines a predetermined vehicle state and a predetermined ambient environment, based on user vehicle data stored in the storage unit 11 (S30). For example, the determination unit 12 may determine a vehicle state and an ambient environment when a trouble occurs in the vehicle used by a user to be a predetermined vehicle state and a predetermined ambient environment. In addition, the determination unit 12 may determine a vehicle state and an ambient environment an appearance frequency of which in the user vehicle data is equal to or greater than a threshold value to be a predetermined vehicle state and a predetermined ambient environment.

Next, the computation unit 13 computes a degree of similarity between the predetermined vehicle state and the predetermined ambient environment determined in S30, and a vehicle state and an ambient environment indicated by a vehicle running test scenario (S31). Next, by magnitude comparison between the computed degree of similarity and a preset reference value, the computation unit 13 extracts a vehicle running test scenario with a degree of similarity to the predetermined vehicle state and the predetermined ambient environment determined in S30 being equal to or greater than the reference value (S32).

Subsequently, the computation unit 13 analyzes data, based on the extraction result (S33). Specifically, the computation unit 13 analyzes a point in common and a point of difference between the predetermined vehicle state and the predetermined ambient environment, and an existing scenario. As described above, the computation unit 13 performs the analysis by a method based on each of a case of a vehicle running test scenario with a degree of similarity to the predetermined vehicle state and the predetermined ambient environment being equal to or greater than the reference value being existent and a case of such a scenario being nonexistent.

Then, the output unit 14 outputs the computation result in S331 (S34). For example, as illustrated in FIG. 9, the output unit 14 may display information for identifying a scenario with a degree of similarity to the predetermined vehicle state and the predetermined ambient environment being equal to or greater than the reference value and may also display a point of difference between the scenario, and the predetermined vehicle state and the predetermined ambient environment. Further, for example, as illustrated in FIG. 10, the output unit 14 may display information for identifying a predetermined number of scenarios in descending order of degree of similarity to the predetermined vehicle state and the predetermined ambient environment and may also display a point in common across the displayed scenarios, the point in common being different from the predetermined vehicle state and the predetermined ambient environment.

The remaining configuration of the processing apparatus 10 is similar to that according to the first example embodiment.

The processing apparatus 10 according to the present example embodiment described above provides advantageous effects similar to those provided by the first example embodiment. Further, after determining a predetermined vehicle state and a predetermined ambient environment in which it is desirable to perform vehicle running testing, based on user vehicle data, the processing apparatus 10 according to the present example embodiment can analyze a point in common and a point of difference between “the predetermined vehicle state and the predetermined ambient environment” and “an existing scenario” and output the result. Based on the information, an operator can easily recognize a point of difference and a point in common between an examination target scenario (a scenario defined by the predetermined vehicle state and the predetermined ambient environment) and an existing scenario and, for example, can examine whether to add the examination target scenario as a new scenario and whether to modify the examination target scenario.

While the present invention has been described with reference to example embodiments (and examples) thereof, the present invention is not limited to the aforementioned example embodiments (and examples). Various changes and modifications that may be understood by a person skilled in the art may be made to the configurations and details of the present invention without departing from the scope of the present invention.

The whole or part of the example embodiments disclosed above may also be described as, but not limited to, the following supplementary notes.
1. A processing apparatus including:
   a determination means for determining a predetermined vehicle state and a predetermined ambient environment, based on user vehicle data indicating a vehicle state and an ambient environment when a user uses a vehicle;
   a computation means for computing a degree of similarity between the predetermined vehicle state and the predetermined ambient environment, and a vehicle state and an ambient environment indicated by a vehicle running test scenario; and
   an output means for outputting a computation result by the computation means.
2. The processing apparatus according to 1, wherein
   the predetermined vehicle state and the predetermined ambient environment are a vehicle state and an ambient environment when a trouble occurs in a vehicle used by the user.
3. The processing apparatus according to 1 or 2, wherein
   the predetermined vehicle state and the predetermined ambient environment are a vehicle state and an ambient environment an appearance frequency of which in the user vehicle data is equal to or greater than a threshold value.
4. The processing apparatus according to any one of 1 to 3, wherein
   the output means outputs, as the computation result, existence of the vehicle running test scenario with the degree of similarity to the predetermined vehicle state and the predetermined ambient environment being equal to or greater than a reference value.
5. The processing apparatus according to 4, wherein,
   when the vehicle running test scenario with the degree of similarity to the predetermined vehicle state and the predetermined ambient environment being equal to or greater than the reference value does not exist,
      the computation means extracts one or more points in common across one or more vehicle states and ambient environments indicated by a predetermined number of the one or more vehicle running test scenarios in descending order of the degree of similarity, and
      the output means outputs the points in common as the computation result.
6. The processing apparatus according to 5, wherein
   the computation means extracts a point different from the predetermined vehicle state and the predetermined ambient environment out of the points in common, and
   the output means outputs, as the computation result, a point different from the predetermined vehicle state and the predetermined ambient environment out of the points in common.
7. The processing apparatus according to any one of 4 to 6, wherein,
   when the vehicle running test scenario with the degree of similarity to the predetermined vehicle state and the predetermined ambient environment being equal to or greater than the reference value exists,
      the computation means extracts a point of difference between a vehicle state and an ambient environment indicated by the vehicle running test scenario with the degree of similarity to the predetermined vehicle state and the predetermined ambient environment being equal to or greater than the reference value, and the predetermined vehicle state and the predetermined ambient environment, and
      the output means outputs the point of difference as the computation result.
8. A processing method including, by a computer:
   determining a predetermined vehicle state and a predetermined ambient environment, based on user vehicle data indicating a vehicle state and an ambient environment when a user uses a vehicle;
   computing a degree of similarity between the predetermined vehicle state and the predetermined ambient environment, and a vehicle state and an ambient environment indicated by a vehicle running test scenario; and
   outputting a computation result.
9. A program for causing a computer to function as:
   a determination means for determining a predetermined vehicle state and a predetermined ambient environment, based on user vehicle data indicating a vehicle state and an ambient environment when a user uses a vehicle;
   a computation means for computing a degree of similarity between the predetermined vehicle state and the predetermined ambient environment, and a vehicle state and an ambient environment indicated by a vehicle running test scenario; and
   an output means for outputting a computation result by the computation means.

What is claimed is:

1. A processing apparatus comprising:
at least one memory configured to store one or more instructions; and
at least one processor configured to execute the one or more instructions to:
determine a predetermined condition based on user vehicle data, the predetermined condition including a predetermined vehicle state and a predetermined ambient environment, the user vehicle data indicating a vehicle state and an ambient environment when a user uses a vehicle;
compute a degree of similarity between the predetermined condition and a test condition, the test condition including a vehicle state and an ambient environment indicated by a vehicle running test scenario; and
output a computation result.

2. The processing apparatus according to claim 1, wherein
the predetermined vehicle state and the predetermined ambient environment are a vehicle state and an ambient environment when a trouble occurs in a vehicle used by the user.

3. The processing apparatus according to claim 1, wherein
the predetermined vehicle state and the predetermined ambient environment are a vehicle state and an ambient environment appearing with a frequency equal to or greater than a threshold value in the user vehicle data.

4. The processing apparatus according to claim 1, wherein the processor is further configured to execute the one or more instructions to output, as the computation result, existence of the vehicle running test scenario whose degree of similarity to the predetermined condition is equal to or greater than a reference value.

5. The processing apparatus according to claim 4, wherein the processor is further configured to execute the one or more instructions to:
in a case that there is no vehicle running test scenario whose degree of similarity to the predetermined condition is equal to or greater than the reference value,
identify predetermined number of vehicle running test scenarios in descending order of the degree of similarity,
extract one or more points in common across one or more vehicle states and ambient environments indicated by a the identified vehicle running test scenarios, and
output the points in common as the computation result.

6. The processing apparatus according to claim 5, wherein the processor is further configured to execute the one or more instructions to:
extract a point different from the predetermined vehicle state and the predetermined ambient environment out of the points in common, and
output, as the computation result, a point different from the predetermined vehicle state and the predetermined ambient environment out of the points in common.

7. The processing apparatus according to claim 4, wherein the processor is further configured to execute the one or more instructions to:
in a case that there is a vehicle running test scenario whose degree of similarity to the predetermined condition is equal to or greater than the reference value,
extract a point of difference between-a the test condition and the predetermined condition, the test condition being indicated by the vehicle running test scenario whose degree of similarity to the predetermined condition is equal to or greater than the reference value and
output the point of difference as the computation result.

8. A processing method comprising, by a computer:
determining a predetermined condition based on user vehicle data, the predetermined condition including a predetermined vehicle state and a predetermined ambient environment, the user vehicle data indicating a vehicle state and an ambient environment when a user uses a vehicle;
computing a degree of similarity between the predetermined condition and a test condition, the test condition including a vehicle state and an ambient environment indicated by a vehicle running test scenario; and
outputting a computation result.

9. A non-transitory storage medium storing a program for causing a computer to:
determine a predetermined condition based on user vehicle data, the predetermined condition including a predetermined vehicle state and a predetermined ambient environment, the user vehicle data indicating a vehicle state and an ambient environment when a user uses a vehicle;
compute a degree of similarity between the predetermined condition and a test condition, the test condition including a vehicle state and an ambient environment indicated by a vehicle running test scenario; and
output a computation result.
